(19) United States
(12) Patent Application Publication
(10) Pub. No.: US 2002/0112140 A1
(43) Pub. Date: Aug. 15, 2002

(54) Semiconductor device, semiconductor device design system, and semiconductor device manufacturing method

(75) Inventor: Takashi Miyamori, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/011,756

(22) Filed: Dec. 11, 2001

(30) Foreign Application Priority Data
Dec. 12, 2000 (JP) 2000-377802

(51) Int. Cl. G06F 15/00; G06F 15/76

(52) U.S. Cl. 712/1

(57) ABSTRACT

An aspect of the present invention provides a design system for providing a description of a configured semiconductor device, including an input unit configured to receive configuration information and a description of the semiconductor device, a description generator configured to set a configurable part in the semiconductor device according to the received configuration information and to generate a configured description of the semiconductor device, the semiconductor device including a storage unit to store the configuration information and a load unit to load the read information from the storage unit into a general register, and an output unit configured to output the configured description of the semiconductor device.

### CROSS REFERENCE TO RELATED APPLICATIONS

This application is based upon and claims benefit of priority from the Japanese Patent Application P2000-377802 filed on Dec. 12, 2000, the entire contents of which are incorporated by reference herein.

### BACKGROUND OF THE INVENTION

1. Field of the Invention

The present invention relates to a semiconductor device, semiconductor device design system, and a semiconductor device manufacturing method. In particular, the present invention relates to a system for providing with a description such as an RTL (register transfer level) description in connection with configured semiconductor device and a method for manufacturing a semiconductor device according to a description of the semiconductor device.

2. Description of the Related Art

Advancement in semiconductor device technology has enabled built-in applications that have been executed on a hardware basis to be executable on a software basis using semiconductor devices such as processors. Applications require different instructions, functions, and memory sizes, and therefore, it is necessary to develop a processor optimized for a given application in a short period of time. To achieve this, configured semiconductor device such as processor have been developed.

The configured semiconductor devices are generally designed to leave the management of their configuration information to software such as compilers, assemblers, simulators, verification programs, real-time OSs, and applications. Managing configuration information by software becomes complicated and troublesome as the number of processors controlled by the software increases.

### SUMMARY OF THE INVENTION

An aspect of the present invention provides a semiconductor device including a storage unit configured to store configuration information indicating the attribute of a configured part in the semiconductor device, and a load unit configured to load the configuration information from the storage unit into a general register.

Another aspect of the present invention provides a design system for providing a description of a configured semiconductor device, including an input unit configured to receive configuration information and a description of the semiconductor device, a description generator configured to set a configurable part in the semiconductor device according to the received configuration information and to generate a configured description of the semiconductor device, the semiconductor device including a storage unit to store the configuration information and a load unit to load the read information from the storage unit into a general register, and an output unit configured to output the configured description of the semiconductor device.

Another aspect of the present invention provides a method of manufacturing a semiconductor device including, receiving configuration information and a description of the semiconductor device, setting a configurable part of the semiconductor device according to the configuration information, generating a description in connection with the semiconductor device including a storage unit of the semiconductor device that stores the configuration information, combining the generated RTL descriptions and other RTL descriptions into a general RTL description for the semiconductor device as a whole, logically synthesizing the general RTL description into a net list, preparing design data concerning the semiconductor device according to the net list, and manufacturing the semiconductor device according to the design data.

### BRIEF DESCRIPTION OF THE DRAWINGS

FIG. 1 is a block diagram showing a semiconductor device design system according to an embodiment of the present invention;

FIG. 2 is a perspective view showing an example of a computer system that realizes the design system of FIG. 1;

FIG. 3 is a block diagram showing part of a semiconductor device formed by the design system of FIG. 1;

FIG. 4 shows examples of an option (OPT) register and a RAM configuration (RCFG) register in the semiconductor device of FIG. 3;

FIG. 5 shows an example of the setting of the OPT register;

FIG. 6 shows another example of the setting of the OPT register; and

FIG. 7 shows a method of manufacturing a semiconductor device according to an embodiment of the present invention.

### DETAILED DESCRIPTION OF EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

A problem in the conventional configured semiconductor devices is that their configuration information must individually be managed by software. To solve this problem, an aspect of the present invention embeds the configuration information in hardware, so that the information may be read by software as and when needed. This solution eliminates the management of the configuration information from software.

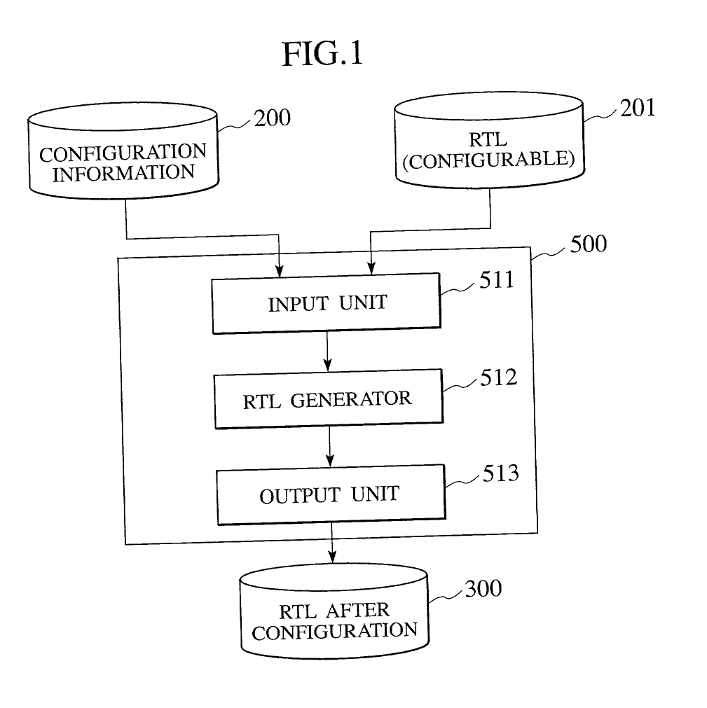

FIG. 1 is a block diagram showing a semiconductor device design system according to an embodiment of the present invention. This system 500 includes an input unit 511 to read configuration information 200 and an RTL (register transfer level) representation 201 of a configured semiconductor device, an RTL generator 512 to generate RTL descriptions according to the input data, and an output unit 513 to provide a configured RTL description 300 of the semiconductor device. The RTL generator 512 defines configurable parts in the RTL description 201 according to the configuration information 200. The configuration information 200 includes data to fix the configurable parts of the RTL description 201 and is used to generate the configured RTL description 300 of the semiconductor device. Generally, a description indicates a configuration of a semiconductor device. The description includes, for example, RTL.

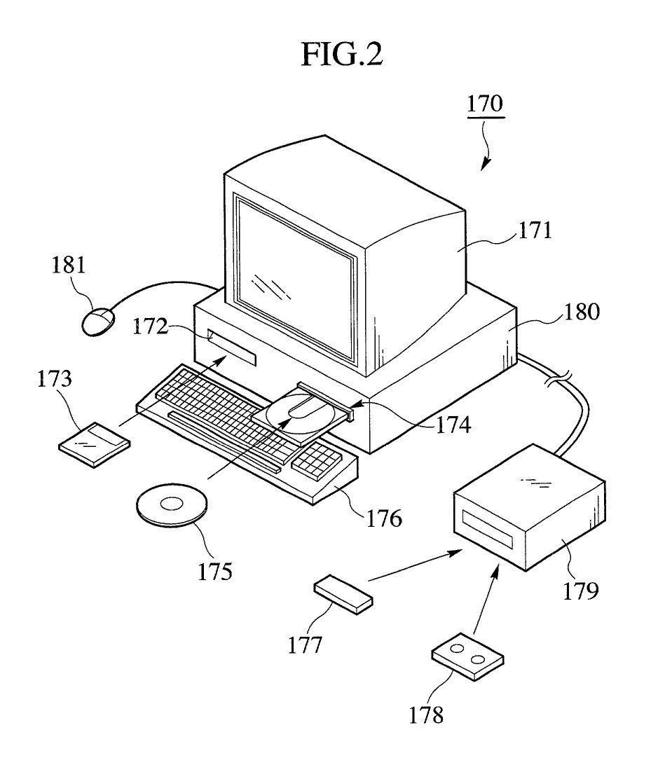

FIG. 2 is a perspective view showing an example of a computer system that realizes the semiconductor device design system of FIG. 1. The system 170 includes a main body 180. The main body 180 is connected to a display 171, a keyboard 176, and a mouse 181. The main body 180 has a floppy disk drive 172 to read a floppy disk 173 and a compact disk drive 174 to read a CD 175. The drive 174 may be a DVD (digital video disk) drive to read a DVD 175. The system 170 also has an external drive 179 to read an external memory 177 or a tape 178 such as a DAT. The floppy disk 173, CD 175, external memory 177, tape 178, etc., are computer-readable storage media capable of storing programs related to a semiconductor device design method and a semiconductor device manufacturing method according to the present invention. The programs stored in the storage media are read by and installed in the system 170, to execute the semiconductor device design method and semiconductor device manufacturing method.

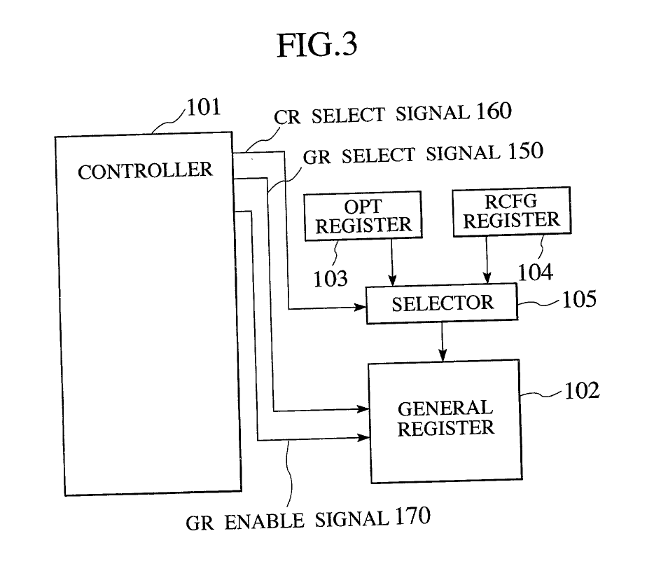

FIG. 3 is a block diagram showing part of a semiconductor device such as a processor configured by the semiconductor device design system according to an embodiment of the present invention. The semiconductor device shown in FIG. 3 realizes a function of reading an option (OPT) register 103 and a RAM configuration (RCFG) register 104 and includes a controller 101, a general register 102, the OPT register 103, the RCFG register 104, and a selector 105. The OPT register 103 and RCFG register 104 store configuration information indicating the attribute of the configuration parts of the semiconductor device. These registers are called the “control registers” in this specification. The configuration information stored in the control registers is specific to the semiconductor device and is invariable, and therefore, the control registers may be read-only registers. Software obtains the configuration information in the control registers to the general register 102 and uses the obtained information. The software may be a compiler, an assembler, a simulator, a verification program, a real-time OS, or an application. There is no need for the software to manage the configuration information of the semiconductor device, and the software can obtain the configuration information from the semiconductor device as and when needed.

The selector 105 selects data in the control registers 103 and 104 in response to a control register select signal 160 from the controller 101. The data selected by the selector 105 is stored in the general register 102 at an address specified by a general register select signal 150 from the controller 101. When storing the selected data into the general register 102, the controller 101 sends a write enable signal 170 to write-enable the general register 102. The configuration information stored in the general register 102 is available for software.

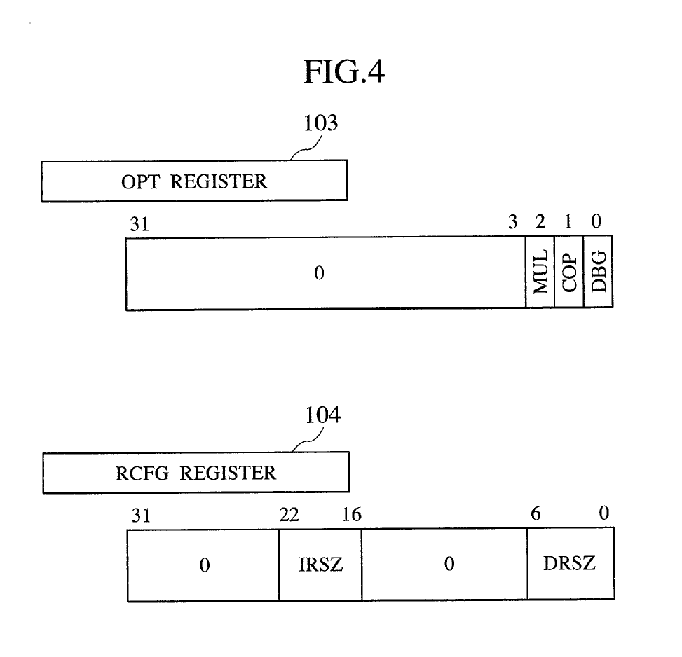

FIG. 4 shows examples of the OPT register 103 and RCFG register 104. According to the embodiment, the configuration information stored in the OPT register 103 indicates the availability of additional functions in the semiconductor device. The OPT register 103 may have a register number of, for example, 10 and a width of, for example, 32 bits. Among the 32 bits, 29 bits from bit 31 to bit 3 are set to “0”. Bit 2 is a multiplication bit. If the semiconductor device is provided with a multiplication instruction, that is, the semiconductor device has a multiplication hardware, the bit 2 is set to “1”, and if not, to “0”. Bit 1 is a coprocessor bit. If the semiconductor device is provided with coprocessor instructions, the bit 1 is set to “1”, and if not, to “0”. Bit 0 is a debug bit. If the semiconductor device is provided with a debugging function, the bit 0 is set to “1”, and if not, to “0”.

The configuration information stored in the RCFG register 104 indicates the sizes of memories. The RCFG register 104 may have a register number of, for example, 11 and a width of, for example, 32 bits. Among the 32 bits, 23 bits from bit 31 and 7 bits from bit 15 are set to “0”. Bit 22 to bit 16 define an instruction-memory-size field (IRSZ) that stores the size of an instruction RAM. Bit 6 to bit 0 define a data-memory-size field (DRSZ) that stores the size of a data RAM. Relationships between values in the fields IRSZ and DRSZ and the sizes of the RAMs are as follows:

| Binary value in IRSZ and DRSZ | RAM size |
|---|---|
| 000000 | 0 (no instruction/data RAM) |
| 000001 | 1 KB |
| 000010 | 2 KB |
| 000100 | 4 KB |
| 001000 | 8 KB |
| 010000 | 16 KB |
| 100000 | 32 KB |

The operation of the semiconductor device formed according to the design system of the present invention will be explained in detail. To read the contents of the OPT register 103 and RCFG register 104, a control register load instruction is executed. This instruction is a 16-bit instruction coded as follows:

0111nnnniiii1011

where “nnnn” indicates a register number (address) in the general register 102 and “iiii” indicates a register number specifying one of the control registers 103 and 104. “iiii” is 1010 (binary) to specify the OPT register 103 having the register number 10 and is 1011 to specify the RCFG register 104 having the register number 11. The contents of the control register specified by the value “iiii” are copied into the general register 102.

In response to the control register load instruction, the controller 101 sends the value “nnnn” with the select signal 150 and the value “iiii” with the select signal 160. At the same time, the controller 101 activates the write enable signal 170. The select signal 160 is sent to the selector 105. If the select signal 160 is “1010,” the selector 105 selects the contents of the OPT register 103, and if the select signal 160 is “1011,” the contents of the RCFG register 104.

The output of the selector 105 is connected to the general register 102. Since the write enable signal 170 is active, the general register 102 writes the output of the selector 105 at the register number (address) specified by the select signal 150. The data stored into the general register 102 is processed by instructions such as transfer instructions, arithmetic instructions, logic instructions, and store instructions executed by the semiconductor device.

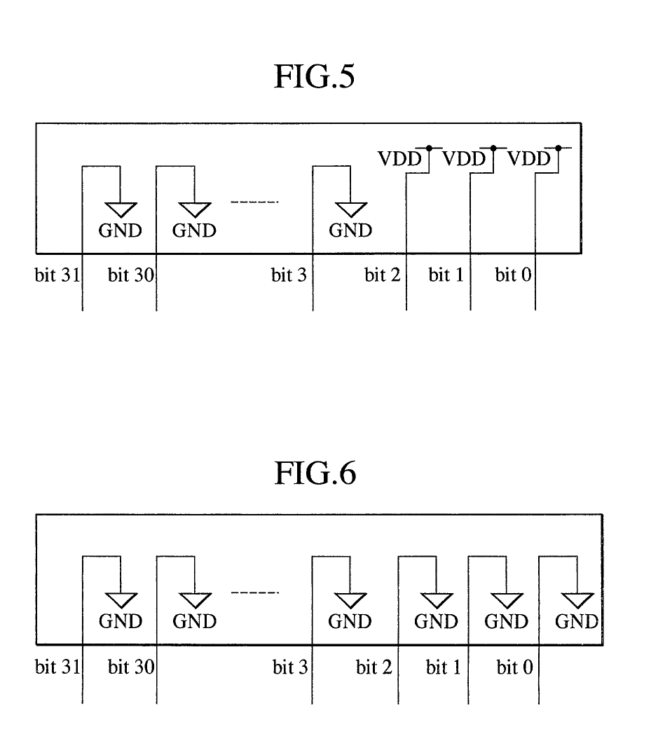

FIG. 5 shows an example of the setting of the OPT register 103. This setting indicates that the semiconductor device is provided with the multiplication instruction, coprocessor instruction, and debugging function. Namely, the bits 31 to 3 are grounded to provide “0” each, and the multiplication bit 2, coprocessor bit 1, and debug bit 0 are connected to VDD to provide “1” each. In this way, the OPT register 103 stores configuration information to assign one of source potential and ground potential to each attribute of the configuration part.

FIG. 6 shows another example of the setting of the OPT register 103. This setting shows that the semiconductor device is provided with none of the multiplication and coprocessor instructions and debugging function. Namely, the bits 31 to 3 are grounded to provide “0” each, and the multiplication bit 2, coprocessor bit 1, and debug bit 0 are also grounded to provide “0” each. In this way, the setting of the OPT register 103 is changed according to the configuration of the semiconductor device. The setting of the RCFG register 104 is also changed according to the sizes of instruction and data RAMs in the semiconductor device.

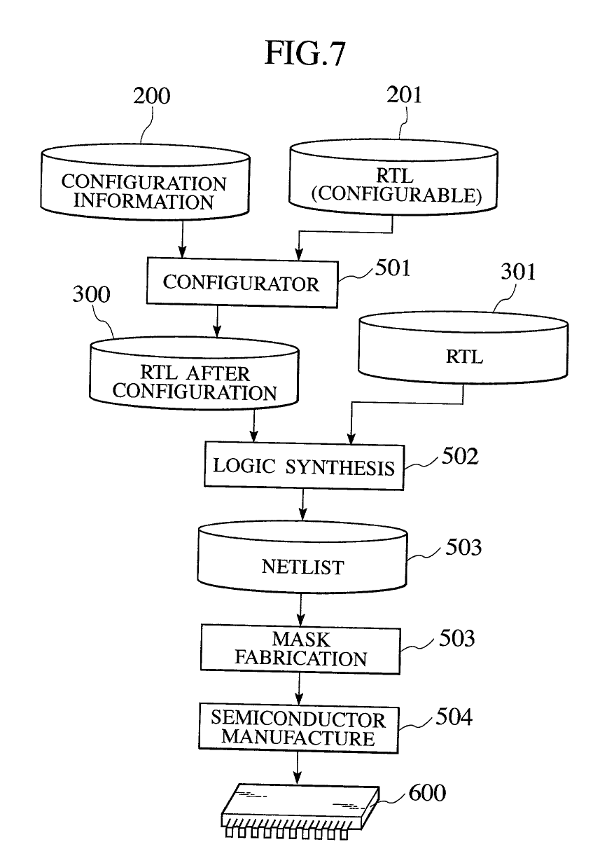

FIG. 7 shows a method of preparing an RTL description of a semiconductor device and a method of manufacturing the semiconductor device based on the RTL description, according to an embodiment of the present invention. Step 501 employs a configurator to configure a configured semiconductor device according to configuration information 200 and an RTL description 201 of the semiconductor device, so that the semiconductor device may have a required configuration. An example of the configuration information 200 is as follows:

CORE {

| MUL=ON; | |
|---|---|
| COP=ON; | |
| DBG=OFF; | |
| } | |
| INST_RAM { | |
| SIZE=16; | //16 KB |
| } | |
| DATA_RAM { | |
| SIZE=16; | //16 KB |

}

This example shows that the semiconductor device is provided with (ON) a multiplication instruction (MUL) and coprocessor instructions (COP) and is not provided with (OFF) a debugging function (DGB). It also shows that the semiconductor device is provided with instruction and data RAMs of 16 KB each.

An example of the RTL description 201 that is configurable is as follows:

\grave{ }ifdef MUL

assign optMULBit=1;

\grave{ }else

assign optMULBit=0;

\grave{ }endif
ifdef COP

assign optCOPBit=1;

\grave{ }else

assign optCOPBit=0;

\grave{ }endif
\grave{ }ifdef DBG

assign optDBGBit=1;

\grave{ }else

assign optDBGBit=0;

\grave{ }endif
assign optReg={29′b0, optMULBit, optCOPBit, optDBGBit};

In this example, the 1st to 5th lines determine whether or not the semiconductor device is provided with the multiplication instruction. If the variable MUL is defined, it is provided with the multiplication instruction, and the signal optMULBit is set to 1 in the 2nd line. If the variable MUL is not defined, it is not provided with the multiplication instruction, and the signal optMULBit is set to 0 in the 4th line.

The 6th to 10th lines determine whether or not the semiconductor device is provided with the coprocessor instructions. If the variable COP is defined, it is provided with the coprocessor instructions, and the signal optCOPBit is set to 1 in the 7th line. If the variable COP is not defined, it is not provided with the coprocessor instructions, and the signal optCOPBit is set to 0 in the 9th line.

The 11th to 15th lines determine whether or not the semiconductor device is provided with the debugging function. If the variable DBG is defined, it is provided with the debugging function, and the signal optDBGBit is set to 1 in the 12th line. If the variable DBG is not defined, it is not provided with the debugging function, and the signal optDBGBit is set to 0 in the 14th line.

The 16th line concatenates higher 29 bits of each 0 and the signals optMULBit, optCOPBit, and optDBGBit, to form a 32-bit value to be stored in an OPT register (103 in FIG. 3) of the semiconductor device.

The configurator used in step 501 is software that generates RTL descriptions in a language of, for example, C, C++, or Perl according to the configuration information 200. The configurator extracts reserved words from the configuration information 200. In this embodiment, the reserved words are MUL, COP, DBG, SIZE, etc. The MUL, COP, and DBG are accompanied by information describing whether or not their corresponding instructions or functions are provided for the semiconductor device. A description of “=ON” indicates that the corresponding instruction or function is provided, and “=OFF” indicates that the corresponding instruction or function is not provided. If a given reserved word is accompanied by “=ON,” the configurator generates an RTL description of “′define.” For example, for the following configuration information:

MUL=ON

the configurator generates the following RTL description:

′define MUL

Consequently, the configurator provides a configured RTL description 300 for the semiconductor device. Step 502 logically synthesizes the RTL description 300 and other RTL descriptions 301 related to the semiconductor device into a gate net list 400. According to the gate net list 400, the semiconductor device is ultimately designed, and mask pattern date is generated accordingly. According to the mask pattern data, step 503 fabricates masks. With the masks, step 504 manufactures the semiconductor device 600 containing the configuration information readable by software.

Although the embodiments mentioned above handle only the multiplication and coprocessor instructions as instruction information to be provided for a semiconductor device, this does not limit the present invention. For example, the instruction information may include an instruction information for counting the number of consecutive 0s or 1s in higher bit positions, a bit operation instruction, a division instruction, a saturated operation instruction, and an SIMD (Single Instruction Stream, Multiple Data Stream) instruction as instructions to be provided for a semiconductor device. In this case, the configuration information 200 includes data related to these instructions.

Although the embodiments mentioned above handle only the debugging function as function information to be provided for a semiconductor device, this does not limit the present invention. For example, the function information may include a memory managing function as function information to be provided for a semiconductor device. In this case, the configuration information 200 includes data related to such a function.

Although the embodiments mentioned above handle only the sizes of instruction and data RAMs as configurable data, this does not limit the present invention. For example, the present invention may handle the numbers of banks in instruction and data RAMs, the sizes of instruction and data caches, an association degree, a line size, a write control method, the number of interrupt controller channels, an interrupt level, and an exception vector start address as configurable data. In this case, the configuration information 200 includes these configurable data pieces.

According to the embodiment of the present invention, configured data related to a semiconductor device is stored as values in registers (103, 104) in the semiconductor device. As a result, software is not required to hold the configuration data related to the semiconductor device. Any semiconductor device such as a processor according to the embodiment of the present invention can properly execute a program according to configuration data stored in the semiconductor device. Software such as compilers, assemblers, simulators, verification programs, real-time OSs, and other applications can read the configuration information stored in the semiconductor device and carry out necessary processes with the read information.

As explained above, an aspect of the present invention stores configuration information in hardware, to simplify the management of the configuration information and properly execute programs by using the configuration information.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein.

What is claimed is:

1. A semiconductor device, comprising:
a storage unit configured to store configuration information indicating the attribute of a configured part in the semiconductor device; and
a load unit configured to load the configuration information from the storage unit into a general register.

2. The semiconductor device as claimed in claim 1, wherein:
the semiconductor device is a processor and the configuration information is one of instruction information and function information.

3. The semiconductor device as claimed in claim 2, wherein:
the instruction information includes at least one of information with regard to a multiplication, coprocessor, counting the number of consecutive 0s or 1s in higher bit positions, a bit operation instruction, a division instruction, a saturated operation instruction, and an SIMD (Single Instruction Stream, Multiple Data Stream) instruction.

4. The semiconductor device as claimed in claim 2, wherein:
the function information includes at least one of information with regard to a debugging function, memory managing function, a size of instruction RAM, a size of data RAM, a number of banks in instruction RAM, a number of banks in RAMs, a size of instruction cache, a size of data cache, an association degree, a line size, a write control method, a number of interrupt controller channels, an interrupt level, an exception vector start address as configurable data.

5. The semiconductor device as claimed in claim 1, wherein:
the storage unit is a read-only register.

6. The semiconductor device as claimed in claim 5, wherein:
the storage unit stores configuration information to assign one of source potential and ground potential to each attribute of the configurable part in the semiconductor.

7. The semiconductor device as claimed in claim 1, wherein:
the storage unit includes a plurality of read-only registers.

8. The semiconductor device as claimed in claim 7, wherein the read unit comprises:
a selector electrically coupled to the registers, the selector configured to selectively read information from the registers according to a select signal; and
a general register configured to store the information read by the selection unit.

9. A design system for providing a description of a configured semiconductor device, comprising:
an input unit configured to receive configuration information and a description of the semiconductor device;
a description generator configured to set a configurable part in the semiconductor device according to the received configuration information and to generate a configured description of the semiconductor device, the semiconductor device including a storage unit to store the configuration information and a load unit to load the read information from the storage unit into a general register; and
an output unit configured to output the configured description of the semiconductor device.

10. The system as claimed in claim 9, wherein:
the configuration information is one of instruction information and function information.

11. The semiconductor device as claimed in claim 10, wherein:
the instruction information includes at least one of information with regard to a multiplication, coprocessor, counting the number of consecutive 0s or 1s in higher bit positions, a bit operation instruction, a division instruction, a saturated operation instruction, and an SIMD (Single Instruction Stream, Multiple Data Stream instruction).

12. The semiconductor device as claimed in claim 10, wherein:
the function information includes at least one of information with regard to a debugging function, memory managing function.

13. The system as claimed in claim 9, wherein:
the storage unit stores configuration information to assign one of source potential and ground potential to each attribute of the configurable part.

14. The system as claimed in claim 9, wherein:
if the semiconductor device is provided with an instruction defined in the configuration information, a bit representing the instruction in the storage unit is set to 1, and if not, the bit is set to 0; and
a value set in the storage unit is transferred to the general register in response to a load instruction.

15. The system as claimed in claim 9, wherein:
if the semiconductor device is provided with a function defined in the configuration information, at least one corresponding bit in the storage part is set accordingly; and
a value set in the storage part is transferred to the general register in response to a load instruction.

16. A computer executable program product for providing a description of a configured semiconductor device, comprising:
instructions for setting a configurable part in the semiconductor device according to a configuration information and generate a configured description of the semiconductor device, the semiconductor device including a storage unit to store the configuration information and a load unit to load the read information from the storage unit into a general register.

17. A method of manufacturing a semiconductor device, comprising:
receiving configuration information and a description of the semiconductor device;
setting a configurable part of the semiconductor device according to the configuration information;
generating a description in connection with the semiconductor device including a storage unit of the semiconductor device that stores the configuration information;
combining the generated RTL descriptions and other RTL descriptions into a general RTL description for the semiconductor device as a whole;
logically synthesizing the general RTL description into a net list;
preparing design data concerning the semiconductor device according to the net list; and
manufacturing the semiconductor device according to the design data.
